(19) United States
(12) Patent Application Publication
(10) Pub. No.: US 2018/0117372 A1
(43) Pub. Date: May 3, 2018

(54) FIREFIGHTER AIR PACK HAVING AN EXTENDABLE HANDLE

(71) Applicant: Jason Mesman, Blue Ash, OH (US)

(72) Inventor: Jason Mesman, Blue Ash, OH (US)

(21) Appl. No.: 15/796,206

(22) Filed: Oct. 27, 2017

Related U.S. Application Data
(60) Provisional application No. 62/414,156, filed on Oct. 28, 2016.

(51) Int. Cl. A62B 35/00

(52) U.S. Cl. CPC A62B 35/0006; A62B 9/04

(57) ABSTRACT

A firefighter air pack includes a rigid frame and a handle housing portion. The firefighter air pack further includes an extendable handle including a gripping portion and at least one telescoping tube portion coupled to the gripping portion. The telescoping tube portion includes at least one tube extendable from and retractable into the handle housing portion.

### CROSS REFERENCE TO RELATED APPLICATION

This application claims the benefit of U.S. Provisional Patent Application Ser. No. 62/414,156, filed Oct. 28, 2016, the disclosure of which is incorporated by reference herein in its entirety.

### TECHNICAL FIELD

This invention generally relates to a firefighter air pack, to which an air tank of a self-contained breathing apparatus may be attached so as to enable a person wearing the air pack to carry the air tank.

### BACKGROUND

Under certain circumstances, a firefighter or another person who may need to work in a hazardous environment, such as a rescue or chemical worker, may wear an air pack to which an air tank of a self-contained breathing apparatus (SOBA) is attachable so as to enable the person wearing the air pack to carry the air tank on his or her back. Thus the air pack may be referred to as an SOBA air pack or a firefighter air pack.

In some instances, a firefighter may become injured, unconscious, and/or trapped in a hazardous environment and may require rescue. Such circumstance may be referred to as a “firefighter down” scenario, and usually requires a rescuer, such as a member of a rapid intervention team (RIT), also referred to as a rapid intervention crew (RIC), to drag the firefighter from the hazardous environment to safety. It will be appreciated that rescuing a firefighter in a hazardous environment can be extremely difficult, as well as dangerous for both the firefighter and the rescuer. In particular, it may be challenging for the rescuer to navigate the downed firefighter around obstacles within the hazardous environment such as, for example, debris and other items along the exit path, as well as sharp corners of doorways and flights of stairs. This difficulty may be exacerbated by the weight of the downed firefighter, which in some instances may be around 300 pounds including the firefighter's gear. In addition, time is of the essence in most rescue situations, and rescuers are usually under a high degree of pressure.

Prior art solutions are limited to addressing a rescuer's ability to grip a firefighter for dragging. For example, firefighter coats may include an integrated tab or loop made of fabric webbing on the backside adjacent the collar portion in order to provide a rescuer with a gripping point on a downed firefighter so that the rescuer may drag the firefighter in a headfirst direction. Similar loops are sometimes provided on a harness or other gear worn by the firefighter. In any event, such loops may be referred to as a drag rescue loop (DRL). However, DRL's are not user friendly in a variety of aspects, and thus can lead to critical delays in rescue.

In a firefighter down scenario, a DRL can be difficult to locate, access, and grip. For example, the dynamic nature of a DRL can allow the DRL to become tucked away or otherwise hidden among the fabric of the firefighter's coat, or snagged by the firefighter's other gear. As such, the location of the DRL may not be readily ascertainable, and a rescuer may be required to reach into the space between a downed firefighter and the firefighter's air pack and manually feel for the DRL. In some instances, various portions of the firefighter's gear may block easy access to the DRL in its hidden location. Once the DRL is located and accessed, the rescuer may be required to tug at or otherwise manipulate the DRL in order to free it so that it may provide a gripping point on the firefighter for the rescuer. Each of these steps requires additional time and effort by the rescuer which could otherwise be expended in removing the downed firefighter from the hazardous environment.

In addition, a DRL may not provide optimal assistance in dragging the downed firefighter safely and efficiently from the hazardous environment. For example, a typical DRL is relatively small and remains close to the downed firefighter's body when gripped. As a result, the rescuer must usually remain in very close proximity with the downed firefighter during the rescue. More specifically, the rescuer must usually remain in contact or near-contact with the downed firefighter. Rescuers must therefore usually choose between dragging the firefighter at a low angle relative to horizontal (e.g. near horizontal), which requires most rescuers to bend or hunch toward or away from the downed firefighter in order to maintain a grip on the DRL, or remaining substantially upright by dragging the firefighter at a high angle relative to horizontal (e.g. near vertical), which requires vertically lifting a substantial portion of the firefighter's weight throughout the dragging process. Either positioning is cumbersome and requires the rescuer to exert a great deal of force and/or effort in order to successfully drag the firefighter.

The dynamic nature of the DRL also inhibits the rescuer's ability to maneuver the firefighter around obstacles along the exit path. For example, the rescuer would not be able to pivot the firefighter around sharp corners of doorways, debris, and other items along the exit path. Rather, in order to clear the obstacle the rescuer must drag the firefighter beyond the obstacle (e.g. completely through a doorway, or completely past a piece of debris), reorient the firefighter's body in the direction of the exit path (which may require momentarily ceasing the dragging), and resume dragging the firefighter along the exit path. This process may need to be repeated for numerous obstacles. In addition, this process may be further complicated in instances when the rescuer is required to release the DRL in order to properly reorient the firefighter's body, which may result in added difficulties in locating, accessing, and gripping the DRL as described above, before resuming dragging the firefighter.

It would therefore be desirable to provide an improved firefighter air pack for providing an easily accessible and deployable gripping point on a firefighter for a rescuer, and for providing improved rescue of the firefighter.

### SUMMARY

In one embodiment, a firefighter air pack includes a rigid frame and a handle housing portion. The firefighter air pack further includes an extendable handle including a gripping portion and at least one telescoping tube portion coupled to the gripping portion. The telescoping tube portion includes at least one tube extendable from and retractable into the handle housing portion.

In another embodiment, a portable handle device for a firefighter air pack includes a handle housing portion and an extendable handle. The extendable handle includes a gripping portion and at least one telescoping tube portion coupled to the gripping portion. The telescoping tube portion includes at least one tube extendable from and retractable into the handle housing portion. The portable handle device further includes a bracket portion coupled to the handle housing portion and including at least one fastening member for selective attachment to an air tank of a firefighter air pack.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an exemplary firefighter air pack having an extendable handle attached thereto.

FIG. 2 is a partial view of the firefighter air pack in FIG. 1, illustrating the extendable handle in a retracted position.

FIG. 3 is a close-up view of the gripping portion of the extendable handle in FIG. 2, illustrating a signal being sent by the extendable handle upon the depressing of the handle's button.

FIG. 4 is a partial side view of the air pack in FIG. 2.

FIG. 5 is a perspective view similar to FIG. 2, illustrating the extendable handle in an extended position.

FIG. 6 is an illustration of a firefighter down scenario wherein a rescuer is using an extendable handle of an air pack to drag a firefighter.

FIG. 7 is a perspective view of an exemplary extendable handle selectively attachable to an air tank of a firefighter air pack.

FIG. 8 is a perspective view of another extendable handle selectively attachable to an air tank of a firefighter air pack.

### DETAILED DESCRIPTION

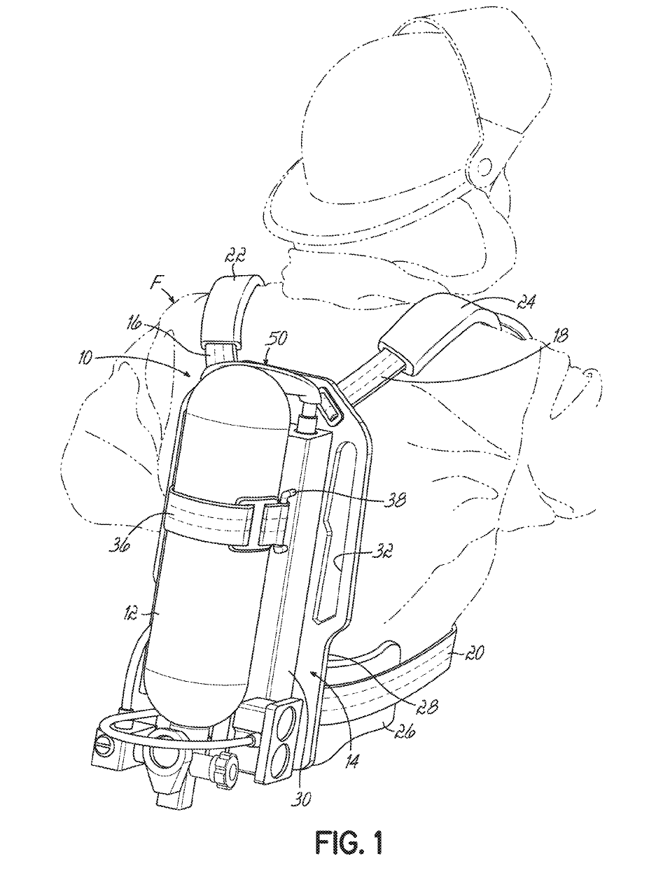

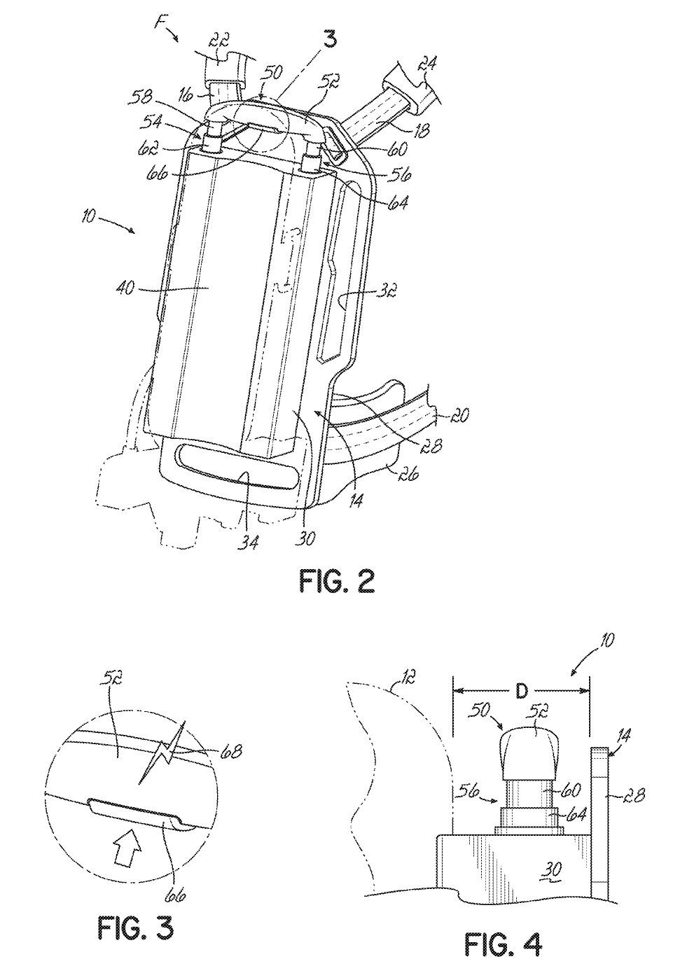

As shown in FIG. 1, an SCBA air pack 10 includes an air tank 12 attached thereto so as to enable a person, such as a firefighter F, wearing the air pack 10 to carry the air tank 12. The air pack 10 includes a rigid frame 14 for attaching various pieces of equipment such as SCBA components, as well as first and second shoulder straps 16, 18 and a waist strap 20 to allow the air pack 10 to be worn by the firefighter F. The air pack 10 may further include first and second shoulder pads 22, 24 and/or waist padding 26 for improved comfort. As shown, the rigid frame 14 includes a support portion 28 and a handle housing portion 30. In one embodiment, the support portion 28 and handle housing portion 30 may be integrally formed together as a unitary piece. In another embodiment, the support portion 28 and handle housing portion 30 may be separately manufactured and coupled together. One or more apertures 32, 34 may be provided in the support portion 28 for handling of the air pack 10 when the air pack 10 is not being used. In the embodiment shown, when in use the air tank 12 is attached to the handle housing portion 30 of the rigid frame 14 via a girding strap 36 coupled to at least one mounting bracket 38 extending from the housing portion 30. The air tank 12 may have a generally cylindrical shape and may at least partially fit against a concavity 40 in the housing portion 30 (FIG. 2) to assist in retaining the air tank 12 on the air pack 10. In other embodiments, the air tank 12 may be attached to the air pack 10 by other means and/or to other portions of the rigid frame 14, such as to the support portion 28.

As set forth in further detail below, the air pack 10 includes an extendable handle 50 which may be retracted within the housing portion 30 for storage and may be extended therefrom by a rescuer to provide the rescuer with an easily accessible and deployable gripping point on the firefighter F and to provide an improved rescue of the firefighter F during a firefighter down scenario. For example, in the extended position the extendable handle 50 provides a rigid or static gripping point at a substantial distance away from the downed firefighter F. As such, rather than requiring a rescuer to drag the firefighter F from a position immediately proximate the firefighter F, the rescuer may be horizontally spaced from the firefighter F and thus drag the firefighter F at a low angle from a comfortable position, thereby lessening the amount of force and/or effort required to move the firefighter F. In addition, rather than requiring cumbersome reorientation of firefighter F at every obstacle, the rigidity or static nature of the extendable handle 50 in the extended position allows the rescuer to pivot the firefighter F around obstacles and thus efficiently maneuver along the exit path while continuing to drag the firefighter F. Therefore, significant amounts of time and effort may be saved by utilizing the extendable handle 50. Such savings can be helpful in a rescue situation wherein time is usually of the essence. The features of the air pack 10 and extendable handle 50 are set forth in further detail below to clarify each of these functional advantages and other benefits provided in this disclosure.

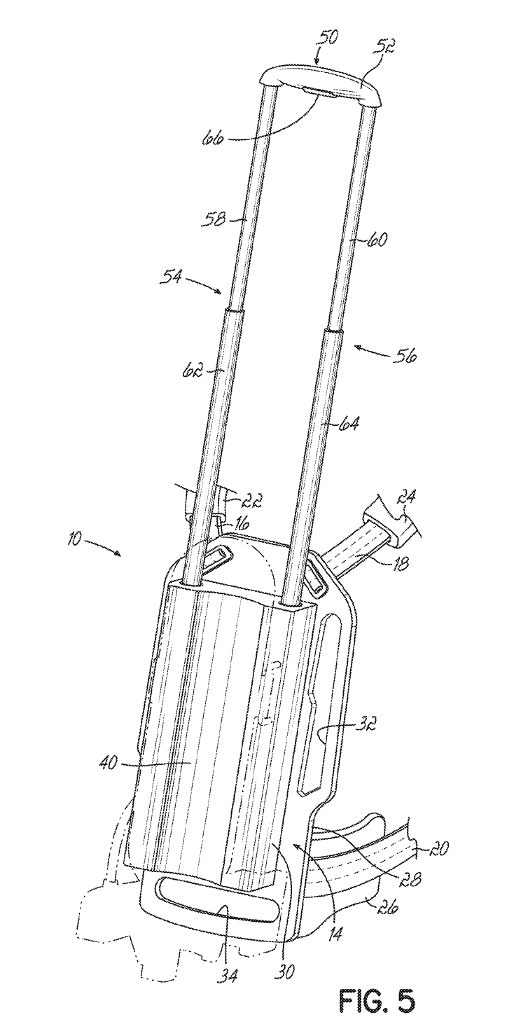

As best shown in FIGS. 2 and 5, the extendable handle 50 may include a gripping portion 52 and first and second telescoping tube portions 54, 56. The general concept of an extendable or telescoping handle is well known and thus will not be explained in great detail. Briefly, in one embodiment each telescoping tube portion 54, 56 includes at least two tubes. For example, each telescoping tube portion 54, 56 may include at least one inner tube 58, 60 disposed within at least one outer tube 62, 64. The inner tubes 58, 60 are rigidly attached to opposite ends of the gripping portion 52, and each inner tube 58, 60 is extendable from and retractable into the corresponding outer tube 62, 64. Similarly, each outer tube 62, 64 is extendable from and retractable into the handle housing portion 30. Stoppers (not shown) may be provided to set predetermined limits to the extension of the tubes 58, 60, 62, 64, such as to prevent the inner tubes 58, 60 from being over extended out of the outer tubes 62, 64 and/or to prevent the outer tubes 62, 64 from being over extended out of the housing portion 30. When the inner tubes 58, 60 are substantially retracted within the outer tubes 62, 64, respectively, and the outer tubes 62, 64 are substantially retracted within the housing portion 30, the extendable handle 50 may be in a fully retracted position (FIG. 2). On the other hand, when the inner tubes 58, 60 are extended from the outer tubes 62, 64, respectively, to a predetermined limit and the outer tubes 62, 64 are extended from the housing portion 30 to a predetermined limit, the extendable handle 50 may be in a fully extended position (FIG. 5).

In another embodiment, the telescoping tube portions 54, 56 may each include only a single tube extendable from and retractable into the housing portion 30. Alternatively, the telescoping tube portions 54, 56 may each include more than two tubes. It should be appreciated that while referred to herein as “tubes,” the innermost tubes (e.g. inner tubes 58, 60) may be solid rather than hollow to improve the strength and/or durability of the extendable handle 50. While the housing portion 30 is illustrated as a single unit, in other embodiments the housing portion 30 may comprise individual sleeves for accommodating each of the telescoping tube portions. In another embodiment, the extendable handle 50 may have only a single telescoping tube portion and thus may be considered a “T”-style handle.

A locking mechanism (not shown) may be provided to automatically maintain the extendable handle 50 in at least one of the fully retracted position or the fully extended position.

A release mechanism may be provided to allow the handle 50 to be moved out of at least one of the fully retracted or fully extended position and toward the other position. For example, a button 66 may be provided on the handle 50, such as on the gripping portion 52, and may be configured to release the locking mechanism when depressed so as to allow the handle 50 to be moved out of the fully retracted or extended position and toward the other position. In one embodiment, at least one of the telescoping tube portions 54, 56 may be spring loaded so as to be biased toward the extended position when the button 66 is depressed in order to aid a rescuer in rapidly deploying the handle 50. In addition or alternatively, as shown in FIG. 3, the extendable handle 50 may be configured to send a signal 68 when the button 66 is depressed. The signal 68 may be, for example, a radio or RFID signal, and may alert the firefighter's supervisor, other firefighters, and/or other rescue personnel that a rescue is in progress so that appropriate action, such as sending additional rescuers, may be taken. The signal 68 may also provide the location of the rescue, such as, for example, via communication with a GPS device associated with the SCBA (not shown).

As shown, the button 66 may be located on a bottom side of the gripping portion 52. This configuration may protect the button 66 from being inadvertently depressed, such as by falling debris or other surroundings of the firefighter F, and so may help prevent accidental deployment of the extendable handle 50. In addition, in this configuration the button 66 may be easily depressed once the rescuer grips the gripping portion 52. Alternatively, the button 66 may be located on a top side of the gripping portion 52, such that the button 66 may be easily accessed and depressed prior to gripping the gripping portion 52. In any event, the button 66 may provide a relatively simple and straightforward means of releasing the extendable handle 50 from the retracted position, such that a rescuer may be able to easily deploy the extendable handle 50 even in a high pressure “panic” situation. However, it will be appreciated that other configurations and release mechanisms may be used such as, for example, a lever, a switch, a knob, or any other suitable release mechanism to allow the handle 50 to be moved out of at least one of the fully retracted or fully extended position and toward the other position.

As shown in FIG. 2, when in the fully retracted position a vertical clearance may be provided between a bottom side of the gripping portion 52 and a top side of the housing portion 30 so as to allow a rescuer's hand (including a glove) to pass therethrough to fully grip the gripping portion 52 while in the fully retracted position. This configuration may allow a rescuer sufficient access to grip the gripping portion 52 and subsequently pull on the gripping portion 52 to move the extendable handle 50 from the retracted position toward the extended position. For example, the distance between the bottom side of the gripping portion 52 and the top side of the housing portion 30 may be between about 1 inch and about 1 and a half inches.

As shown in FIG. 4, the air pack 10 may be configured to provide horizontal clearances on either side of the extendable handle 50 when in the fully retracted position so as to allow a rescuer's hand (including a glove) to pass therethrough to fully grip the gripping portion 52. For example, the support portion 28 of the rigid frame 14 may be spaced apart from an air tank 12 attached to the air pack 10 by a distance D. This distance D may be sufficiently large such that the voids on either side of the gripping portion 52 are able to accommodate a rescuer's hand. Similar to the previously mentioned vertical clearance, this configuration may allow a rescuer sufficient access to grip the gripping portion 52 and subsequently pull on the gripping portion 52 to move the extendable handle 50 from the retracted position toward the extended position. In addition or alternatively, the distance D may be sufficiently small such that when in the fully retracted position the gripping portion 52 may be flanked by the air tank 12 and/or the support portion 28 and thereby protected from undesirable snagging or other interference with the firefighter's clothing or surroundings during normal use. For example, the distance between the gripping portion 52 and the air tank 12 may be between about a half inch and about 1 and a half inches, and the distance between the gripping portion 52 and the rigid frame 14 may be between about a half inch and about 1 and a half inches. In one embodiment, each distance may be about 1 inch.

With specific reference to FIG. 5, when the extendable handle 50 is in the fully extended position, the gripping point (e.g. at gripping portion 52) may be located a substantial distance away from the housing portion 30, and thus may be located a similar distance away from the firefighter F wearing the air pack 10, by virtue of the lengths of the telescoping tube portions 54, 56 in the fully extended position. This length may be sufficiently great to allow a rescuer to grip the gripping portion 52 and drag the firefighter F at a relatively low angle without undesirable hunching or bending down toward or away from the firefighter F. The length may allow the rescuer to drag the firefighter F up stairs without such hunching. For example, the length of the telescoping tube portions 54, 56 may be between about 15 inches and about 30 inches. In one embodiment, the length may be between about 18 inches and about 30 inches. Since the handle 52 in the extended position is not dynamic, but rather is rigid or static, the rescuer may be able to efficiently maneuver the firefighter F along the exit path, such as by pivoting the firefighter F around obstacles while continuously dragging the firefighter F.

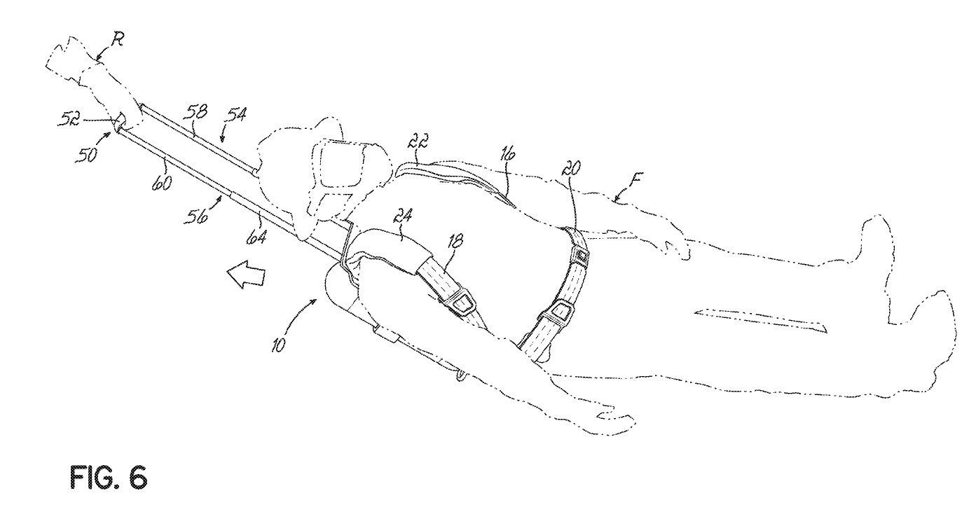

Turning now to FIG. 6, a firefighter down scenario is illustrated wherein a rescuer R is dragging the downed firefighter F in a headfirst direction via the extendable handle 50 of the firefighter's SCBA air pack 10. As shown, the extendable handle 50 has been deployed into the fully extended position from the fully retracted position. As previously described, this may be performed by the rescuer R gripping the gripping portion 52 in the fully retracted position, depressing the button 66 to release the locking mechanism, and pulling the handle 50 from the fully retracted position toward the fully extended position. In addition or alternatively, a spring loading may assist the rescuer R in rapidly deploying the handle 50. Once in the fully extended position, the locking mechanism may maintain the handle 50 in the fully extended position. Thus, the deployment of the handle 50 by the rescuer R may be quickly performed and thereby allot more time for moving the firefighter F to safety.

As shown, in the extended position the handle 50 provides the rescuer R with a gripping point (e.g. at the gripping portion 52) rigidly coupled to the firefighter F at a substantial distance away from the firefighter F. Unlike a conventional DRL, this allows the rescuer R to drag the firefighter F at a low angle relative to horizontal while remaining substantially upright, thereby minimizing the amount of force and effort that the rescuer R is required to exert in order to successfully drag the firefighter F, and improving the rescuer's overall comfort. And, in the event that the rescuer R encounters an obstacle along the exit path, the rigidity or static nature of the handle 50 in the extended position allows the rescuer to pivot the firefighter F around the obstacle while continuously dragging the firefighter F, rather than painstakingly dragging the firefighter F beyond the obstacle, reorienting the firefighter's body, and resuming dragging. Thus, the extendable handle 50 may expedite the rescue process and improve the likelihood of a successful rescue.

In one embodiment, various components of the extendable handle 50 and/or the handle housing portion 30 may be constructed of one or more lightweight materials to minimize the burden on the firefighter F during routine use of the air pack 10, and to minimize the amount of force and effort that a rescuer R is required to exert to drag the firefighter F by the handle 50 in a rescue situation. In addition or alternatively, various components of the extendable handle 50 and/or the handle housing portion 30 may be constructed of one or more strong and/or durable materials in order to sustain the tensions exerted thereon by a rescuer R when dragging a downed firefighter F. For example, each of the inner and outer tubes 58, 60, 62, 64 may be constructed of a material having a tensile strength sufficient to prevent fracture, deformation, or other breakage when under tension between the rescuer's pulling force and the firefighter's weight, including the firefighter's gear. In one embodiment, the extendable handle 50 may be rated for a firefighter weight of up to approximately 300 pounds including gear. Components of the extendable handle 50 and/or the handle housing portion 30 may be constructed of steel.

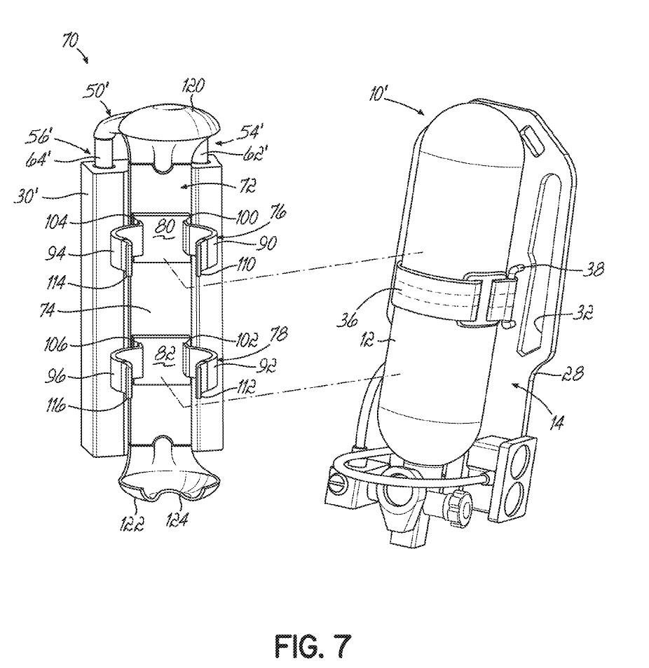

With reference now to FIG. 7, wherein like numerals represent like features, in an alternative embodiment a portable handle device 70 including an extendable handle 50′ is selectively attachable to an air tank 12 of a firefighter air pack 10′. As shown, the air tank 12 may be attached to the support member 28 of the rigid frame 14, and the air pack 10′ may not be equipped with the extendable handle 50 previously described. Thus, the air pack 10′ may resemble a conventional air pack. In the event of a firefighter down scenario wherein the downed firefighter's air pack 10′ is not equipped with the extendable handle 50, a rescuer may bring the portable handle device 70 to the scene and attach the device 70 to the firefighter's air tank 12. The rescuer may then deploy the extendable handle 50′ and drag the downed firefighter in a manner similar to that previously described.

As shown, the device 70 may include a bracket portion 72 attached to a rear surface of the handle housing portion 30′. In one embodiment, the bracket portion 72 and the handle housing portion 30′ may be integrally formed together as a unitary piece. In another embodiment, the bracket portion 72 and handle housing portion 30′ may be separately manufactured and coupled together.

The bracket portion 72 may include an elongate body 74 and a variety of fastening members mounted thereto for selective attachment of the device 70 to the air tank 12. For example, the bracket portion 72 may include first and second C-shaped clamps 76, 78. Each of the first and second C-shaped clamps 76, 78 may include a base portion 80, 82 disposed along and rigidly coupled to the elongate body 74, and a set of first and second arms 90, 92, 94, 96 extending from the base portion 80, 82. Each of the arms 90, 92, 94, 96 may include a fixed end 100, 102, 104, 106 coupled to the base portion 80, 82 and a free end 110, 112, 114, 116. Each set of first and second arms 90, 92, 94, 96 may be configured to provide a snap fit over a portion of the air tank 12. For example, each set of first and second arms 90, 92, 94, 96 may be spaced apart, sized, and/or shaped to generally correspond to a surface of the air tank 12. In addition, or alternatively, the first and second arms 90, 92, 94, 96 may be constructed of a semi-flexible material. In particular, the free ends 110, 112, 114, 116 of a set of first and second arms 90, 92, 94, 96 may be capable of bending away from each other as the respective C-shaped clamp 76, 78 is forced over the air tank 12, and may bend back toward each other once the air tank 12 has been received by the C-shaped clamp 76, 78 such that the C-shaped clamp 76, 78 may exert a pressure on, and thereby grip, the air tank 12. While two C-shaped clamps 76, 78 are shown, any number of C-shaped clamps may be used. Alternatively, straps or other temporary fastening members may be used in place of C-shaped clamps. For example, straps similar to the girding strap 36 may be used.

As shown, the bracket portion 72 may include upper and lower caps 120, 122 extending from top and bottom ends of the elongate body 74, respectively. Each of the upper and lower caps 120, 122 may be curved and/or generally cup-shaped to correspond to top and bottom surfaces of the air tank 12, respectively. As shown, the lower cap 122 may include a recess 124 for accommodating a component of the air tank 12 and/or air pack 10′ such as, for example, a nozzle, coupling, pressure gauge, and/or regulator of the air tank 12 or air pack 10′. When the air tank 12 is received by the C-shaped clamps 76, 78, the upper and lower caps 120, 122 may be configured to exert a pressure on the air tank 12 to assist in gripping and/or retaining the air tank 12. To that end, one or both of the upper and lower caps 120, 122 may be constructed of a semi-flexible material such that at least one of the caps 120, 122 may be capable of bending away from the other as the C-shaped clamps 76, 78 are forced over the air tank 12 and bending back toward the other once the air tank 12 has been received by the C-shaped clamps 76, 78. In addition or alternatively, one or both of the upper and lower caps 120, 122 may be slidable and lockable along the elongate body 74 so that a rescuer may increase the distance between the caps 120, 122 sufficiently to allow the air tank 12 to pass therebetween and subsequently decrease the distance between the caps 120, 122 to clamp down on the air tank 12. This adjustability may also allow a single portable handle device 70 to be usable for a variety of different air tank sizes. While upper and lower caps 120, 122 are shown, in another embodiment, different fastening members may be used. For example, the lower cap 122 may be replaced with a fork member for accommodating a component of the air tank 12 and/or air pack 10′ in a manner similar to the recess 124.

Various components of the portable handle device 70 may be constructed of materials similar to those previously discussed with respect to the extendable handle 50 and housing portion 30 for similar reasons. For example, lightweight materials may be used to minimize the burden on a rescuer bringing the device 70 to the scene. Strong and/or durable materials may be used such that the device 70 may sustain the tensions exerted thereon by a rescuer when dragging a downed firefighter. Of the fastening members on the bracket portion 72, it will be appreciated that the lower cap 122 may be under the most stress and/or strain during use of the portable handle device 70 wherein the rescuer is dragging the downed firefighter by the extendable handle 50′ in a headfirst direction. Thus, in one embodiment the lower cap 122 may be constructed of a material having a higher strength and/or durability than one or more of the other fastening members. Alternatively, the various fastening members may be constructed of the same or similar materials.

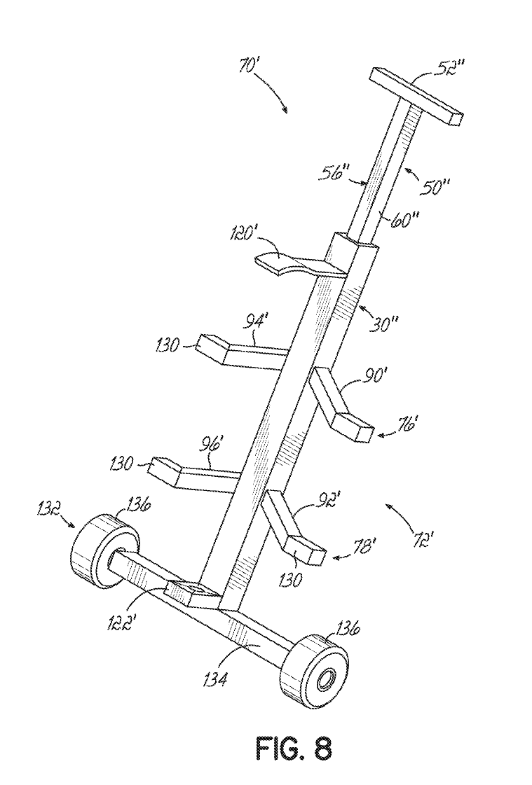

FIG. 8 illustrates yet another alternative embodiment of a portable handle device 70′ similar to portable handle device 70 illustrated in FIG. 7. The portable handle device 70′ includes a handle housing portion 30″ configured as an elongate beam that receives extendable handle 50″. In this embodiment, the extendable handle 50″ includes only a single telescoping tube portion 56″ having inner and outer tubes 60″ and 64″ and gripping portion 52″. Similar to the previous embodiment, the portable handle device 70′ includes a bracket portion 72′ for selective attachment of the device 70′ to the air tank 12. The bracket portion 72′ may include upper and lower caps 120′, 122′ adjacent the top and bottom ends of the handle housing portion 30′. The bracket portion 72′ may further include first and second V-shaped clamps 76′, 78′ having diverging arms 90′, 92′, 94′, 96′. Each of the arms 90′, 92′, 94′, 96′ terminate with a flange or lip 130. The diverging configuration of the arms 90′, 92′, 94′, 96′ allows the portable handle device 70′ to be attached to air tanks 12 of different sizes.

In a further aspect in accordance with the invention, the portable handle device 70′ includes a transport mechanism 132 that facilitates the transport of a downed firefighter when in the configuration illustrated in FIG. 6. In this regard, and as illustrated in FIG. 8, the transport mechanism 132 may include a support member 134 coupled to the handle housing portion 30″ adjacent its lower end. For example, in an exemplary embodiment the support member 134 may extend transverse to the elongate beam that forms the handle housing portion 30″. At least one wheel, and preferable a pair of wheels 136 may be coupled to the support member 134 adjacent opposed ends thereof. Thus, when a firefighter has to be transported in a firefighter down scenario, the wheels 136 may facilitate the movement of the firefighter such that the transport to a safe location occurs more quickly and with significantly less effort.

The portability and compact nature of the device 70, 70′ in the fully retracted position allow a rescuer to bring the device 70, 70′ to the scene of a firefighter down scenario wherein the air pack 10′ of the downed firefighter may not be equipped with an extendable handle 50 as previously described. For example, a rescuer who is a member of a rapid intervention team (RIT), also referred to as a rapid intervention crew (RIC) may carry a rescue bag or RIT (or RIC) bag to the scene. Such bags are typically used to store various rescue items such as, for example, rope, air tanks, and masks, and may be used to store the portable handle device 70, 70′. Thus, the device 70, 70′ may be incorporated into the standard rescue gear carried by a rescuer to the scene of a firefighter down scenario. The rescuer may quickly and easily couple the device 70, 70′ to the air tank 12 using the fastening members of the bracket portion 72, 72′. The extendable handle 50′, 50″ may be deployed and used to drag the firefighter to safety in a manner similar to that previously described with respect to the extendable handle 50. Thus, various benefits of an extendable handle 50, 50′, 50″ such as those previously discussed may be realized even when the downed firefighter's air tank 10′ is not already equipped with an extendable handle 50.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. The various features of the invention may be used alone or in numerous combinations depending on the needs and preferences of the user.

What is claimed is:

1. A firefighter air pack comprising:
a rigid frame;
a handle housing portion; and
an extendable handle including a gripping portion and at least one telescoping tube portion coupled to the gripping portion, the at least one telescoping tube portion including at least one tube extendable from and retractable into the handle housing portion.

2. The firefighter air pack of claim 1, wherein the extendable handle is in a fully extended position when the at least one tube is extended from the handle housing portion to a predetermined limit, and wherein the extendable handle is in a fully retracted position when the at least one tube is substantially retracted within the handle housing portion.

3. The firefighter air pack of claim 2, further comprising a locking mechanism configured to retain the extendable handle in at least one of the fully extended position or the fully retracted position.

4. The firefighter air pack of claim 3, further comprising a release mechanism configured to release the locking mechanism such that the extendable handle may be moved out of the at least one of the fully extended position or the fully retracted position and toward the other position.

5. The firefighter air pack of claim 4, wherein the release mechanism is configured to send a signal indicating that a rescue is in progress.

6. The firefighter air pack of claim 4, wherein the release mechanism includes a button.

7. The firefighter air pack of claim 6, wherein the button is positioned on a bottom side of the gripping portion.

8. The firefighter air pack of claim 1, wherein the at least one telescoping tube portion includes first and second telescoping tube portions coupled to opposite ends of the gripping portion.

9. The firefighter air pack of claim 1, wherein the at least one tube includes at least one inner tube and at least one outer tube, wherein the at least one inner tube is extendable from and retractable into the at least one outer tube, and wherein the at least one outer tube is extendable from and retractable into the handle housing portion.

10. The firefighter air pack of claim 1, wherein the rigid frame further comprises a support portion.

11. The firefighter air pack of claim 10, wherein the support portion and the housing portion are integrally formed as a unitary piece.

12. The firefighter air pack of claim 4, wherein the extendable handle is biased toward the fully extended position.

13. The firefighter air pack of claim 1, further comprising an air tank selectively attached to the handle housing portion.

14. The firefighter air pack of claim 13, further comprising a bracket portion coupled to the handle housing portion for selectively attaching the air tank to the handle housing portion.

15. A portable handle device for a firefighter air pack, comprising:
a handle housing portion;
an extendable handle including a gripping portion and at least one telescoping tube portion coupled to the gripping portion, the at least one telescoping tube portion including at least one tube extendable from and retractable into the handle housing portion; and
a bracket portion coupled to the handle housing portion and including at least one fastening member for selective attachment to an air tank of a firefighter air pack.

16. The portable handle device of claim 15, wherein the at least one fastening member includes at least one C-shaped clamp or V-shaped clamp having first and second arms.

17. The portable handle device of claim 15, wherein the at least one fastening member includes upper and lower caps configured to exert a pressure on the air tank.

18. The portable handle device of claim 15, wherein the at least one fastening member is constructed of a semi-flexible material.

19. The portable handle device of claim 15, wherein the extendable handle is in a fully extended position when the at least one tube is extended from the handle housing portion to a predetermined limit, and wherein the extendable handle is in a fully retracted position when the at least one tube is substantially retracted within the handle housing portion.

20. The portable handle device of claim 19, further comprising a locking mechanism configured to retain the extendable handle in at least one of the fully extended position or the fully retracted position.

21. The portable handle device of claim 15, further comprising a transport mechanism having at least one wheel.
